(19) United States
(12) Patent Application Publication
(10) Pub. No.: US 2004/0227300 A1
(43) Pub. Date: Nov. 18, 2004

(54) Device for sealing a gap

(76) Inventors: Iwan Wolf, Chur (CH); Ulrich Rosenbaum, Wangs (CH); Urs Muller, Jenaz (CH); Joachim Thieleke, Wasserburg (DE); Thomas Granacher, Schaan (CH); Gebhard Gantner, Nenzing (AT)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/388,012

(22) Filed: Mar. 13, 2003

(30) Foreign Application Priority Data
Mar. 14, 2002 (DE) 102 11 366.1

(51) Int. Cl. F02F 5/00

(52) U.S. Cl. 277/434

(57) ABSTRACT

A device for sealing a gap (7) between a first cylindrical part (2) and a second cylindrical part (5), in which the first cylindrical part (2) is received, includes a sealing ring (8) located in a circumferential groove (9) formed in the outer circumferential surface of the first cylindrical part (2), and at least one elastic element (10) located in the circumferential groove (3) for biasing the sealing ring (8) radially outwardly.

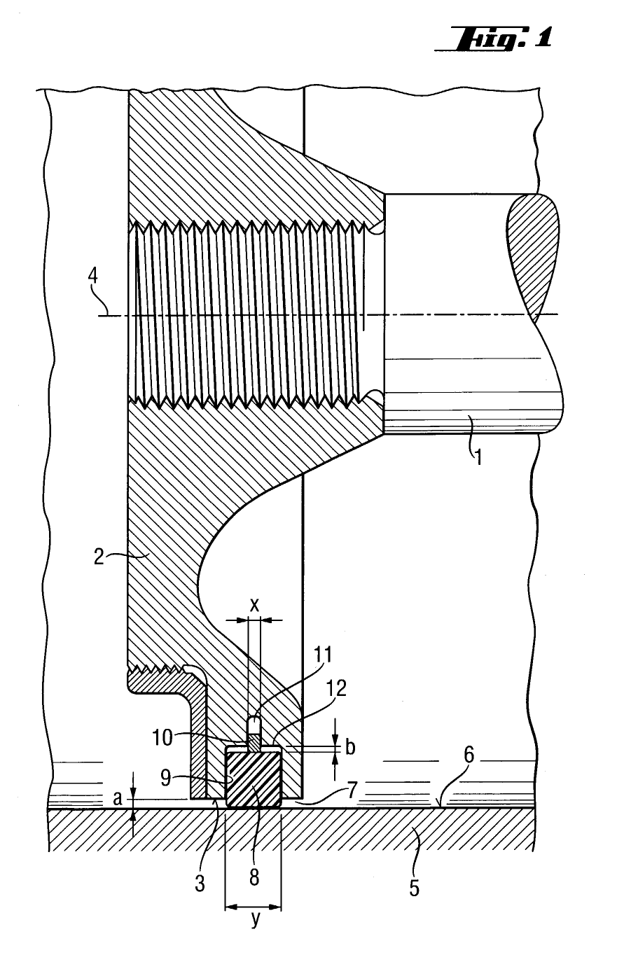

### BACKGROUND OF THE INVENTION

1. Field of the Invention

The present invention relates to a device for sealing a gap between a first cylindrical part and a second cylindrical part in which a first cylindrical part is received and, in particular, to a sealing device for use in a combustion-engined setting tool for driving-in fastening elements for sealing a gap between a piston peak and a cylinder in which the piston plate, together with a piston rod, are displaceable.

2. Description of the Prior Art

Sealing devices of the type described above, in which a sealing ring is located in a circumferential groove formed in the outer circumferential surface of the first cylindrical part, are known.

It was found that in conventional sealing devices, the sealing action of the sealing ring diminishes with time because of wear of the sealing ring, and a normal operation of means, in which the sealing device is used, in particular, of the setting tool cannot be ensured.

Accordingly, an object of the invention is a sealing device of the type described above that would ensure a necessary sealing effect for a long period of time.

### SUMMARY OF THE INVENTION

This and other objects of the present invention, which will become apparent hereinafter, are achieved by providing a sealing device having a sealing ring located in a circumferential surface of the first cylindrical part and at least one elastic element located in the circumferential groove for biasing the sealing ring radially outwardly. With the elastic element, the sealing ring is constantly preloaded radially outwardly and is pressed against the second cylindrical part. This ensures a long service life of the device despite the wear, with a reliable sealing of the gap. Further, because of the increase of the service life of the sealing ring itself, as a result of the increase of the service life of the device, the sealing ring needs to be replaced after a longer time interval, which is associated with reduced maintenance costs. Thus, the use of the inventive device is accompanied by noticeable economical advantages.

As it has already been mentioned above, the first cylindrical part can be formed, in the combustion-engined setting tools, e.g., as a piston plate connectable with a piston rod and displaceable in a cylinder.

As an elastic element, in principle, any element can be used which is supported against the first cylindrical part and biases the sealing ring radially outwardly. The sealing element can be formed, e.g., of several parts uniformly or equidistantly distributed over the circumference of the first cylindrical part. Advantageously, however, the elastic element is formed as a spring ring extending over the entire circumference of the first cylindrical part. Also, several spring rings can be arranged next to each other for biasing the sealing ring radially outwardly. Forming the elastic element as a sealing ring (or rings) ensures application of a uniform pressure to the sealing ring over the entire circumference of the sealing ring, which also increases the service life of the sealing ring.

Advantageously, the elastic element is formed of a metal having a relatively small thermal expansion coefficient. This prevents high temperatures, which are produced in course of a long operation, from causing a high friction between the sealing ring and the inner wall of the second cylindrical part. The low friction reduces the wear of the sealing ring. It is particularly advantageous to form the elastic element of a steel that, on one hand, has a relatively small thermal expansion coefficient and, on the other hand, is capable of retaining its elastic characteristics at high temperatures and during a long-lasting operation.

Advantageously, the elastic element is located between the bottom of the circumferential groove, in which the sealing ring is received, and the sealing ring. In principle, however, the elastic elements can be located in the side regions of the circumferential groove. In this case, the sealing ring, upon being inserted in the groove, should be capable of riding over the elastic element.

According to a particular advantageous embodiment of the present invention, there is formed, in the bottom of the circumferential groove in which the sealing ring is received, a depression for receiving the elastic element. This ensures that the sealing ring can be supported against the bottom of the circumferential groove when a dynamic radial load is applied to the sealing ring. In this way, a controlled radial load is applied to the elastic element, which ensures that the elastic element would not limit the displacement, in the radial direction, of the sealing ring. When the elastic element is formed as a spring ring, the depression is formed as an annular ring extending over the circumference of the first cylindrical part. The annular groove has a smaller axial width than that of the circumferential groove for receiving the sealing ring. Generally, several annular grooves, arranged next to each other in the axial direction, can be provided for receiving several spring rings in case several spring rings are needed for sealing reasons and/or to ensure stability.

Advantageously, according to the invention, the depth of the sealing ring-receiving circumferential groove is smaller than the radial thickness of the sealing ring. This prevents the first cylindrical part from being damaged at the maximum radial deflection of the sealing ring. Even at its maximum radial deflection, the sealing ring projects beyond the circumferential edge of the first cylindrical part. The foregoing dimensioning of the sealing ring and the sealing ring-receiving circumferential groove ensures that the distance between the outer diameter of the sealing ring and the outer surface of the first cylindrical part is greater than the distance between the inner diameter of the sealing ring and the bottom of the sealing ring-receiving circumferential groove.

The novel features of the present invention, which are considered as characteristic for the invention, are set forth in the appended claims. The invention itself, however, both as its construction and its mode of operation, together with additional advantages and objects thereof, will be best understood from the following detailed description of preferred embodiments, when read with reference to the following drawings.

### BRIEF DESCRIPTION OF THE DRAWINGS

Single FIGURE of the drawings shows a cross-sectional view of section of a combustion-engined setting tool in which a sealing device according to the present invention is used.

### DETAILED DESCRIPTION OF THE PREFERRED EMBODIMENT

As shown in the drawing, in the combustion-engined setting tool, a section of which is shown in the drawing, a piston rod 1 is connected with a piston plate 2 an outer surface 3 of which is coaxial with a central axis 4 of the piston rod 1. The piston plate 2, together with the piston rod 1, are displaceably arranged in a cylinder 5. For sealing a gap 7, which is formed between the outer surface 3 of the piston plate 2 and the inner wall 6 of the cylinder 5, an elastic sealing ring 8 is provided. The sealing ring 8 is located in a circumferential groove 9 which is formed in the outer surface 3 of the piston plate 2. As shown in the drawing, viewed in the axial direction, the spaced, parallel, side walls of the sealing ring 8 tightly abut the respective parallel side walls of the circumferential groove 9, ensuring a good seal therebetween. The sealing ring 8, however, is displaceable in radial direction of the piston plate 2. The sealing ring 8 has a rectangular, in particular, square cross-section. The radially outer circumferential surface of the sealing ring 8 is pressed against the inner wall 6 of the cylinder 5 for sealing the gap 7 which is formed between the outer circumferential surface 3 of the piston plate 2 and the inner wall of the cylinder 5.

In order to ensure that the sealing element 5 always engages the inner wall 6 of the cylinder 5 without backlash, even in case of wear, there is provided, viewed in the radial direction, behind the sealing ring 8, a circumferentially resilient or spring ring 10. The spring ring 10 biases the sealing ring 8 radially outwardly against the inner wall 6 of the cylinder 5 with a predetermined force. The spring ring 10, which extends over the entire circumference of the piston plate 3 ensures that a uniform circumferential pressure, which acts radially outwardly, is applied to the sealing ring 8. Advantageously, the spring ring 10 is formed of a steel having a relative small thermal expansion coefficient. Forming the ring 10 of such steel ensures that the sealing ring 8 would not apply too strong a pressure to the inner wall 6 of the cylinder 5 even after a long duration of an operation and at high temperatures. Thereby, an excessive wear of the sealing element 8 is prevented.

The spring ring 10 is arranged in a circumferential annular groove 11 formed in the bottom of the circumferential groove 9 for the sealing ring 8. Viewed in the axial direction, the annular groove 11 has a smaller width than the circumferential groove 9. Thereby, at a dynamic radial loading of the system, the sealing ring 8 is supportable against the bottom 12 of the circumferential groove 9. This provides for an application of a controlled load to the spring ring 10 so that it does not unduly limit the displacement of the sealing ring 8. As has already been discussed above, the axial width x of the annular groove 11 is smaller than the axial width y of the circumferential groove 9. Advantageously, the annular groove 11 is located in the middle of the bottom 12 of the circumferential groove 9.

The sealing arrangement according to the present invention is so designed that during an operation the distance a between the outer circumferential surface of the elastic sealing ring 8 and the inner wall 6 of the cylinder 5 is always greater than the distance b between the inner circumferential surface of the sealing ring 8 and the bottom 12 of the circumferential groove 9. This ensures that the outer surface 3 of the piston plate 2 would not be damaged even at a maximum deflection of the sealing ring 8 when the sealing ring 8 lies on the bottom 12, as even in this case, the outer surface 3 of the piston plate 2 would be spaced from the inner wall 6 of the cylinder 5. In other words, the radial thickness of the sealing ring 8 is greater than the depth of the circumferential groove 9 in which the sealing ring 8 is received.

Although the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A device for sealing a gap (7) between a first cylindrical part (2) and a second cylindrical part (5) in which the first cylindrical part (2) is received, the device comprising a sealing ring (8) located in a circumferential groove (9) formed in an outer circumferential surface of the first cylindrical part (2); and at least one elastic element (10) located in the circumferential groove (3) for biasing the sealing ring (8) radially outwardly.

2. A device according to claim 1, wherein the elastic element (10) is formed as a spring ring.

3. A device according to claim 2, wherein the spring ring (10) is formed of metal.

4. A device according to claim 3, wherein the spring ring (10) is formed of steel.

5. A device according to claim 1, wherein the elastic element (10) is located between the bottom (12) of the circumferential groove (9) and the sealing ring (8).

6. A device according to claim 5, further comprising a depression formed in the bottom (12) of the circumferential groove (9) for receiving the elastic element (10).

7. A device according to claim 6, wherein the depression is formed as annular groove (11) extending over a circumference of the first cylindrical part (2).

8. A device according to claim 6, wherein the circumferential groove (9) has a depth smaller than a radial thickness of the sealing ring (8).

9. A device according to claim 1, wherein the first cylindrical part (2) is a piston plate.

10. A combustion-engined setting tool, comprising a cylinder (5); a piston displaceable in the cylinder (5) and having a piston plate (2); and a device for sealing a gap (7) between the outer circumferential surface of the piston plate (2) and an inner wall of the cylinder (5), the device having a sealing ring (8) located in a circumferential groove (9) formed in an outer circumferential surface of the piston plate (2); and at least one elastic element (10) located in the circumferential groove (3) for biasing the sealing ring (8) radially outwardly.
